(19) United States
(12) Patent Application Publication
(10) Pub. No.: US 2013/0093850 A1
(43) Pub. Date: Apr. 18, 2013

(54) IMAGE PROCESSING APPARATUS AND METHOD THEREOF

(71) Applicants: Chia-Ho LIN, Hsinchu County (TW); Jian-De Jiang, Xian (CN); Guang-Zhi Liu, Shanghai (CN)

(72) Inventors: Chia-Ho LIN, Hsinchu County (TW); Jian-De Jiang, Xian (CN); Guang-Zhi Liu, Shanghai (CN)

(73) Assignee: NOVATEK MICROELECTRONICS CORP., Hsinchu (TW)

(21) Appl. No.: 13/537,830

(22) Filed: Jun. 29, 2012

(30) Foreign Application Priority Data
Oct. 17, 2011 (CN) 201110314365.8

(51) Int. Cl. H04N 13/02; G06K 9/00

(52) U.S. Cl. 348/46; 382/154; 348/E13.074

(57) ABSTRACT

An image processing method is disclosed. A 2D image is virtually divided into a plurality of blocks. With respect to each block, an optimum contrast value and a corresponding focus step are obtained. An object distance for an image in each block is obtained according to the respective focus step of each block. A depth map is obtained from the object distances of the blocks. The 2D image is synthesized to form a 3D image according to the depth map.

This application claims the benefit of People's Republic of China application Serial No. 201110314365.8, filed Oct. 17, 2011, the subject matter of which is incorporated herein by reference.

### BACKGROUND OF THE DISCLOSURE

1. Technical Field

The disclosure relates in general to an image processing apparatus and method thereof.

2. Description of the Related Art

3D (three-dimension) content may be produced by way of animation (CG), photography and simulation (2D image to 3D image conversion). Conversion of 2D image to 3D image involves high complication and high difficulty. Better technologies are required for producing 3D images with satisfactory results to meet the future requirements. In the simulation process of generating 3D images from 2D images by algorithms, some assumptions are made. For example, it is assumed that the bottom part of the image is closer, the top part of the image is farther, the object moving faster is regarded as being closer, and one object is located at the same distance.

The TV and movie industries use professional camera equipment with 3D photography function to obtain high fidelity 3D images.

### SUMMARY OF THE DISCLOSURE

The disclosure is directed to an image processing apparatus and a method thereof in which a 3D image is generated (simulated) based on focusing information.

According to an exemplary embodiment of the present disclosure, an image processing method is disclosed. With respect to each block, an optimum contrast value and a corresponding focus step are obtained. An object distance for an image in the block is obtained according to the respective focus step of the block. A depth map is obtained from the object distances of the blocks. The 2D image is synthesized to form a 3D image according to the depth map.

According to another exemplary embodiment of the present disclosure, an image processing apparatus is disclosed. The image processing apparatus includes a control unit, a lens moving unit, a capturing unit, and a lens. The lens moving unit is coupled to the control unit. The capturing unit is coupled to the control unit. The lens is moved by the lens moving unit. The control unit divides a 2D image into a plurality of blocks. The lens moving unit moves the lens with respect to each block to obtain an optimum contrast value and a corresponding focus step. The control unit obtains an object distance of an image in the block according to the focus step of the block. The control unit obtains a depth map from the object distances of the blocks. The control unit synthesizes the 2D image to form a 3D image according to the depth map.

The above and other contents of the disclosure will become better understood with regard to the following detailed description of the preferred but non-limiting embodiment (s). The following description is made with reference to the accompanying drawings.

### BRIEF DESCRIPTION OF THE DRAWINGS

FIG. 1 shows a functional block diagram of a digital image processing apparatus according to one embodiment of the disclosure;

FIG. 2 shows a flowchart of a digital image processing method according to the embodiment of the disclosure;

FIG. 3 shows virtual division of a 2D image into 4×4 blocks according to the embodiment of the disclosure;

FIG. 4 shows a correspondence relationship between normalized contrast values and focus steps; and

FIG. 5 shows focus steps corresponding to optimum contrast value in each block.

### DETAILED DESCRIPTION OF THE DISCLOSURE

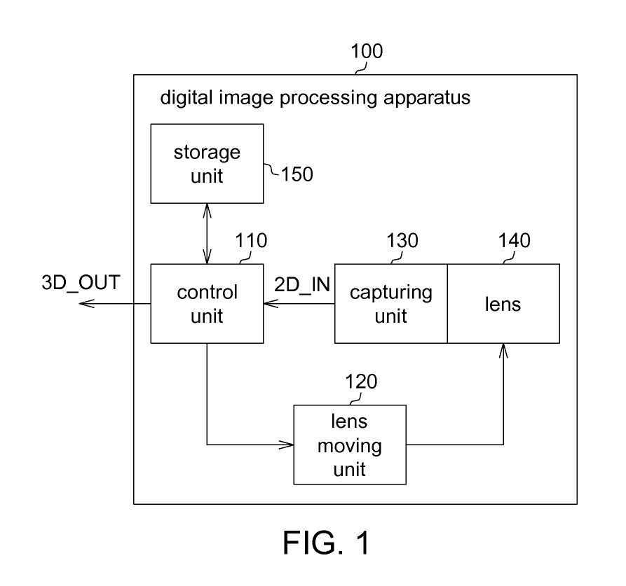

Referring to FIG. 1, a functional block diagram of a digital image processing apparatus according to one embodiment of the disclosure is shown. As indicated in FIG. 1, the digital image processing apparatus 100 includes a control unit 110, a lens moving unit 120, a capturing unit 130, a lens 140 and a storage unit 150.

The lens moving unit 120 moves the lens 140. The capturing unit 130 shoots an external object through the lens 140 to generate a 2D image 2D_IN. The focusing of the lens 140 affects the result of the image capture.

The control unit 110, formed by such as a micro-processor and other circuits, determines a scene depth (that is, an object distance is determined by the control unit) according to a focusing information during the focusing process, to synthesize the 2D image captured by the capturing unit 130 into a 3D image 3D_OUT.

The storage unit 150 may store a correspondence table representing a relationship between focus steps and object distances.

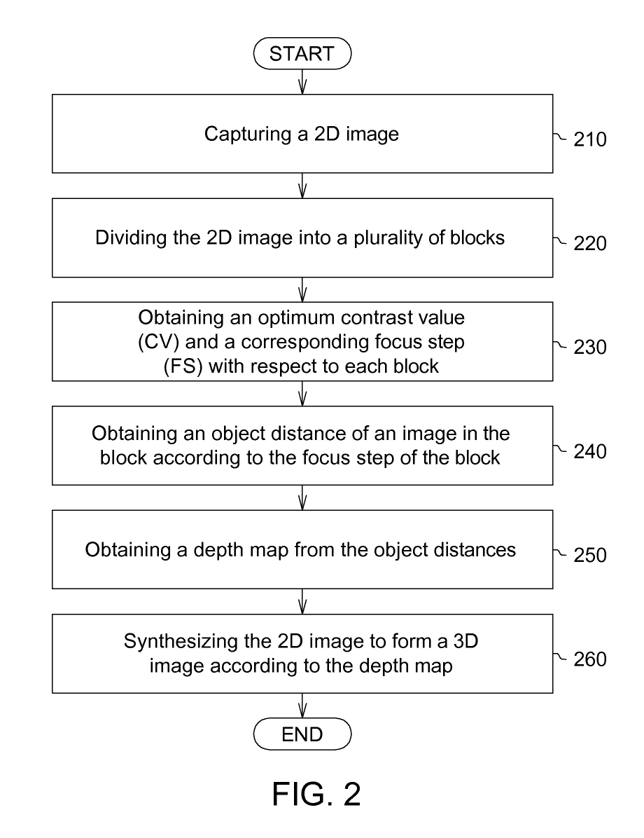

FIG. 2 a flowchart of a digital image processing method according to the present embodiment of the disclosure. Referring to FIG. 1 and FIG. 2 at the same time.

In step 210, a 2D image is captured. In the present embodiment of the disclosure, the capturing unit 130 shoots through the lens 140 to generate the 2D image 2D_IN and sends the 2D image 2D_IN to the control unit 110.

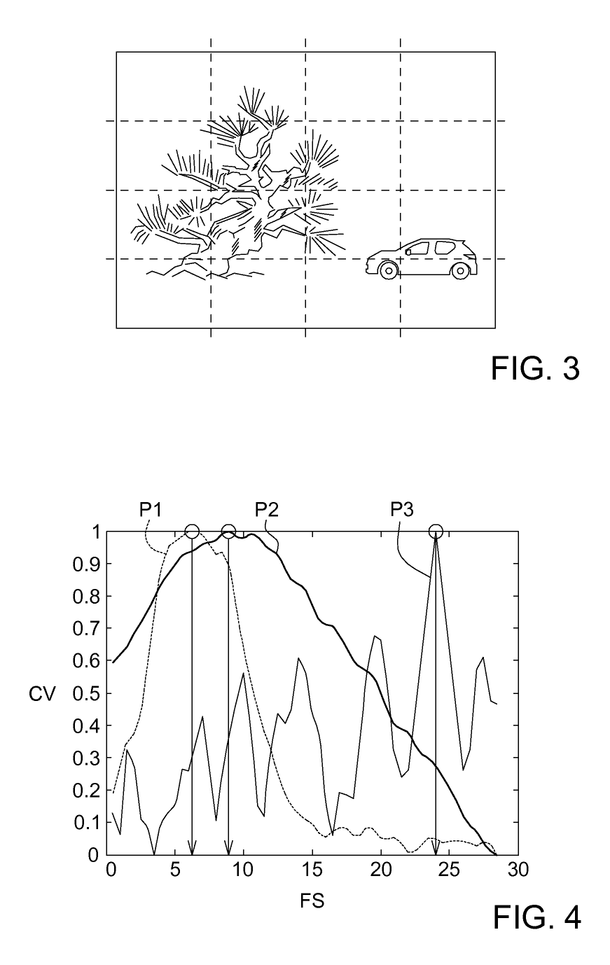

In step 220, the captured 2D image is virtually divided into a plurality of blocks. For example, the control unit 110 virtually divides the 2D image 2D_IN into a plurality of blocks. For convenience of elaboration, the 2D image 2D_IN is virtually divided into 4×4 blocks, but it is understood that the disclosure is not limited thereto. FIG. 3 shows virtual division of a 2D image into 4×4 blocks according to the embodiment of the disclosure.

In step 230, an optimum contrast value (CV) and a corresponding focus step (FS) are obtained with respect to each block. For example, in the automatic focusing process, a correspondence relationship between contrast values and focus steps is obtained with respect to each block. For one of the blocks, when the focus step of the lens 140 is 0, the contrast value of the captured image is F[0]; when the focus step of the lens 140 is 5, the contrast value of the captured image is F[5]. By the same analogy, the maximum focus step of the lens 140 is exemplified by 30, but it is understood that the disclosure is not limited thereto. The maximum value of the contrast values F[0]˜F[30], selected by such as the control unit 110, is defined as the optimum contrast value. In addition, there are many ways to change the focus step, for example, to gradually change the focus step.

FIG. 4 shows a correspondence relationship between normalized contrast values and focus steps. As indicated in FIG. 4, for block P1, the focus step corresponding to the optimum focusing ratio is 6; for block P2, the focus step corresponding to the optimum contrast value is 9; and for block P3, the focus step corresponding to the optimum contrast value is 24.

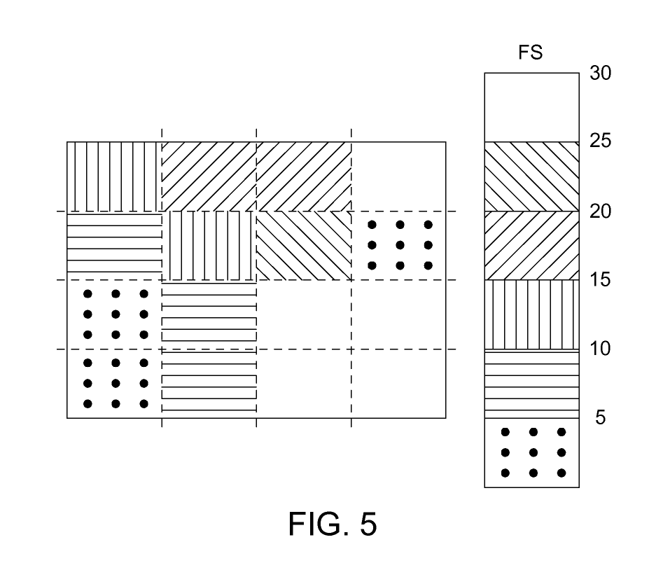

FIG. 5 shows focus steps corresponding to optimum contrast value in each block. As indicated in FIG. 5, the focus steps are categorized into several groups such as group 1 (focus steps 0˜5), group 2 (focus steps 5˜10), group 3 (focus steps 10˜15), group 4 (focus steps 20˜25), and group 5 (focus steps 25˜30).

In step 240, the object distance of the image in the block is obtained according to the focus step of the block. In the present embodiment of the disclosure, a correspondence table between the focus step and the object distance is stored in the storage unit 150. Thus, corresponding object distance may be obtained based on the focus step by looking up the table. The step 240 may be performed by the control unit 110.

For example, if the focus step is 0, the object distance is infinite. If the focus step is 5, the object distance is 30 meters. However, it is understood that the present embodiment of the disclosure is not limited thereto.

In step 250, a depth map is obtained based on the object distances of the blocks. For example, in the present embodiment of the disclosure, the object distances are used as the depth information of the depth map.

In step 260, the 2D image is synthesized to form a 3D image according to the depth map. In the present embodiment of the disclosure, the details of synthesizing 2D images to form 3D images are not specified, and any known technologies of synthesizing 2D images to form 3D images may be used. For example, a left eye image and a right eye image are respectively generated from 2D image and they are synthesized to form a 3D image according to the depth map.

The present embodiment of the disclosure may be used in electronic products with photography and automatic focusing functions such as digital cameras, digital video recorders, mobile phones and Tablet PC.

Since a single capturing unit is enough in the present embodiment of the disclosure, the manufacturing cost is low. Moreover, since the architecture of the present embodiment of the disclosure is similar or identical to that of the common middle-level or low-level electronic products, minor or even no modifications need to be done to the architecture.

In the present embodiment of the disclosure, the scene depth is determined according to the statistical data (such as object distance) in the focusing process to synthesize the 2D image to form a 3D image. Therefore, the 3D image of the present embodiment is obtained according to actual depth map, and the embodiment of the disclosure has better simulation than conventional 2D to 3D image conversion.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An image processing method, comprising:
dividing a 2D image into a plurality of blocks;
obtaining an optimum contrast value and a corresponding focus step with respect to each block;
obtaining a respective object distance of an image in each block according to the respective focus step of each block;
obtaining a depth map from the respective object distances of the blocks; and
synthesizing the 2D image to form a 3D image according to the depth map.

2. The image processing method according to claim 1, wherein, the step of obtaining the respective optimum contrast value and the corresponding focus comprises:
gradually adjusting the focus step with respect to the block to obtain a plurality of contrast values; and
selecting a maximum value from the contrast values as the optimum contrast value.

3. The image processing method according to claim 2, further comprising:
normalizing the contrast values.

4. The image processing method according to claim 1, wherein,
obtaining the respective object distances of the images in the blocks based on the respective focus steps of the blocks by looking up a table.

5. The image processing method according to claim 1, wherein,
the respective object distances are directly used as depth information of the depth map.

6. An image processing apparatus, comprising:
a control unit;
a lens moving unit coupled to the control unit;
a capturing unit coupled to the control unit; and
a lens moved by the lens moving unit;
wherein, the control unit divides a 2D image into a plurality of blocks;
the lens moving unit moves the lens with respect to each block to obtain an optimum contrast value and a corresponding focus step;
the control unit obtains a respective object distance of an image in each block according to the respective focus step of each block;
the control unit obtains a depth map from the respective object distances of the blocks; and
the control unit synthesizes the 2D image to form a 3D image according to the depth map.

7. The image processing apparatus according to claim 6, wherein,
the lens moving unit gradually moves the lens with respect to the block to gradually adjust the focus step of the lens to obtain a plurality of contrast values; and
the control unit selects a maximum value from the contrast values as the optimum contrast value of the block.

8. The image processing apparatus according to claim 7, wherein, the control unit normalizes the contrast values.

9. The image processing apparatus according to claim 6, further comprising a storage unit coupled to the control unit, wherein the storage unit stores a correspondence relationship between the focus step and the object distance;
wherein, the control unit looks up the correspondence relationship stored in the storage unit to obtain the respective object distances of the respective images in the blocks based on the respective focus steps of the blocks.

10. The image processing apparatus according to claim 6, wherein,
the control unit directly uses the respective object distance as depth information of the depth map.
